(19) United States
(12) Patent Application Publication
(10) Pub. No.: US 2024/0204375 A1
(43) Pub. Date: Jun. 20, 2024

(54) THREE-ELECTRODE CELL AND SYSTEM FOR PERFORMANCE ANALYSIS USING SAME

(71) Applicant: LG ENERGY SOLUTION, LTD., Seoul (KR)

(72) Inventor: Solnip LEE, Daejeon (KR)

(21) Appl. No.: 18/288,561

(22) PCT Filed: Oct. 21, 2022
(86) PCT No.: PCT/KR2022/016125

§ 371 Date: Oct. 26, 2023

(30) Foreign Application Priority Data
Dec. 20, 2021 (KR) 10-2021-0182857
Oct. 13, 2022 (KR) 10-2022-0131188

(51) Int. Cl. H01M 50/569; H01M 50/105

(52) U.S. Cl. CPC H01M 50/569; H01M 50/105

(57) ABSTRACT

The present disclosure relates to a three-electrode cell and a system for performance analysis using same, and the purpose of the present disclosure is to provide a three-electrode cell in which an electrode indentation phenomenon and an internal short circuit phenomenon are suppressed, and a system for performance analysis using the three-electrode cell.

### CROSS-REFERENCE TO RELATED APPLICATION

The present application is a National Phase entry pursuant to 35 U.S.C. § 371 of International Application No. PCT/KR2022/016125, filed on Oct. 21, 2022, and claims the benefit of and the priority to Korean Patent Application No. 10-2021-0182857, filed on Dec. 20, 2021, and Korean Patent Application No. 10-2022-0131188, filed on Oct. 13, 2022, the entire contents of which are hereby incorporated by reference in their entirety.

### TECHNICAL FIELD

The present disclosure relates to a three-electrode battery and a performance analysis system using the same, and relates to a three-electrode battery in which electrode pitting and internal short-circuits are suppressed, and a performance analysis system using the same.

### BACKGROUND

A three-electrode analysis system using a reference electrode is mainly used for the cathode/anode separation analysis of a secondary battery. In a conventional three-electrode system, a thin copper wire coated with an LTO (Li₄Ti₅O₁₂) active material is used as a reference electrode.

Specifically, as shown in FIG. 1, in the three-electrode battery, a Cu wire coated with an LTO active material may be inserted as a reference electrode 14 into a separator 13 stacked between a cthode 11 and an anode 12. More specifically, the separator 13 between the cathode 11 and the anode 12 is provided in two layers, and the reference electrode 14 may be located between the two layers of the separator 13.

At this time, when a wire-type reference electrode is used, as shown in FIG. 2, due to the shape of the reference electrode 14, a blocking area is generated, and thus an unreacted area is formed, making it difficult to perform accurate cathode/anode separation analysis.

Depending on the stiffness or thickness of the electrode itself, the size of the blocking area may be enlarged and become a problem, and in particular, when the pressure increases in the area where the reference electrode is located due to the increase in the internal pressure of the battery due to the increase in the thickness of the electrode and the generation of gas generated while the battery is operating, damage to the electrode and the separator may occur.

Therefore, there is a need for a technology for a battery or system capable of stable three-electrode analysis regardless of the electrode's own properties and whether or not it is operated.

The background description provided herein is for the purpose of generally presenting context of the disclosure. Unless otherwise indicated herein, the materials described in this section are not prior art to the claims in this application and are not admitted to be prior art, or suggestions of the prior art, by inclusion in this section.

### SUMMARY

### Technical Goals

The present disclosure relates to a three-electrode battery and a performance analysis system using the same, and provides a three-electrode battery in which electrode pitting and internal short circuits are suppressed, and a performance analysis system using the same.

The technical problems to be achieved by the present disclosure are not limited to the technical problems mentioned above, and other technical problems not mentioned will be clearly understood by those skilled in the art from the description below.

### Technical Solutions

A three-electrode battery of the present disclosure may include:
a main separator;
a film-shaped reference electrode on a first side of the main separator;
an auxiliary separator on the first side of the main separator with the reference electrode interposed therebetween;
a first electrode and a second electrode disposed with the main separator, the reference electrode, and the auxiliary separator interposed therebetween; and
a battery case accommodating the main separator, the reference electrode, the auxiliary separator, the first electrode, and the second electrode in an inner space therein.

In the three-electrode battery of the present disclosure, the reference electrode may comprise a plurality of perforated holes.

A performance analysis system of the present disclosure may include:
a working electrode connecting part connected to the first electrode to measure an electrode potential of the first electrode;
a counter electrode connecting part connected to the second electrode;
a reference electrode connecting part connected to the reference electrode; and
a measuring part connected to the working electrode connecting part, the counter electrode connecting part, and the reference electrode connecting part to measure the electrode potential of the first electrode.

### Advantageous Effects

According to a three-electrode battery and a performance analysis system using the same of the present disclosure, it is possible to minimize the area of the blocking area due to the reference electrode, and suppress occurrence of circuit problems such as internal short circuit or electrode damage such as electrode pitting due to changes in battery internal pressure.

The three-electrode battery of the present disclosure and performance analysis system using the same may be capable of highly reliable separation analysis of the cathode/anode regardless of the electrode's own physical properties and whether or not it is operated.

The three-electrode battery of the present disclosure may be advantageous for analysis of Si/SiO batteries with significant thickness changes or long-term degradation analysis.

In the three-electrode battery of the present disclosure, an effect of reducing three-electrode deviation can be expected due to the reduction of the blocking area.

The three-electrode battery of the present disclosure has a structure that is easy to design for a medium or large-sized battery, and can be applied regardless of the stack or area of electrodes.

### BRIEF DESCRIPTION OF DRAWINGS

FIG. 1 is a conceptual diagram illustrating a conventional three-electrode battery.

FIG. 2 is a cross-sectional view illustrating a conventional three-electrode battery.

FIG. 3 is a cross-sectional view illustrating a three-electrode battery of the present disclosure.

FIG. 4 is an exploded perspective view illustrating a stacked structure of a three-electrode battery of the present disclosure.

FIG. 5 is a plan view illustrating a disposition relationship between a first electrode and a reference electrode.

FIG. 6 is a graph illustrating battery characteristics according to an open ratio of a first region.

FIGS. 7A to 7C are photographs illustrating a state of a battery electrode according to a reference electrode.

FIG. 8 is a graph illustrating depth of charge at 1 C charge and 2 C charge.

### DETAILED DESCRIPTION

A three-electrode battery of the present disclosure may include:
a main separator;
a film-shaped reference electrode stacked on one side of the main separator;
an auxiliary separator stacked on the one side of the main separator with the reference electrode interposed therebetween;
a first electrode and a second electrode stacked with the main separator, the reference electrode, and the auxiliary separator interposed therebetween; and
a battery case in which the main separator, the reference electrode, the auxiliary separator, the first electrode, and the second electrode are accommodated in an inner space.

In the three-electrode battery of the present disclosure, the reference electrode may be formed with a plurality of perforated holes.

In the three-electrode battery of the present disclosure, the reference electrode may include a first region facing the first electrode or the second electrode, and a second region protruding from one side of the first electrode or the second electrode, and the plurality of perforated holes may be formed in the first region.

The three-electrode battery of the present disclosure may further include a reference electrode lead having one end fused to the second region of the reference electrode and the other end protruding out of the battery case.

In the three-electrode battery of the present disclosure, the first electrode or the second electrode may be provided in a rectangular shape having a first direction and a second direction orthogonal to each other as corners, when a length of the first electrode or the second electrode in the first direction is formed to be longer than a length in the second direction, a length of the first region in the first direction may be formed to be 1% to 3% of the length of the first electrode or the second electrode in the first direction, and a length of the first region in the second direction may be formed to be 5% to 95% of the length of the first electrode or the second electrode in the second direction.

In the three-electrode battery of the present disclosure, the reference electrode may include a foil member forming a body, and a reference electrode active material coated on the foil member.

In the three-electrode battery of the present disclosure, a material of the foil member may include at least one of Cu-foil and Al-foil.

In the three-electrode battery of the present disclosure, the reference electrode active material may be selected from a group consisting of LTO (Li₄Ti₅O₁₂), LFP (LiFePO₄), Li metal, and combinations thereof.

A performance analysis system of the present disclosure may include:
a working electrode connecting part connected to the first electrode to measure an electrode potential of the first electrode;
a counter electrode connecting part connected to the second electrode;
a reference electrode connecting part connected to the reference electrode; and
a measuring part connected to the working electrode connecting part, the counter electrode connecting part, and the reference electrode connecting part to measure the potential of the first electrode.

Hereinafter, with reference to the accompanying drawings, embodiments according to the present disclosure will be described in detail. In this process, the size or shape of the components shown in the drawings may be exaggerated for clarity and convenience of description. In addition, in consideration of the configuration and operation of the present disclosure, specially defined terms may vary depending on the intentions or practices of users and operators. Definitions of these terms should be based on the content throughout this specification.

In the description of the present disclosure, it should be noted that an orientation or positional relationship indicated by the terms “center”, “top”, “bottom”, “left”, “right”, “vertical”, “horizontal”, “inside”, “outside”, “one side”, “other side”, and the like, is based on an orientation or positional relationship shown in the drawings, or an orientation or positional relationship that is usually placed when using a product of the present disclosure, and is intended only for explanation and brief description of the present disclosure, and is not to be construed as limiting the present disclosure because it does not suggest or imply that a device or element shown should necessarily be configured or operated in a specific orientation with a specific orientation.

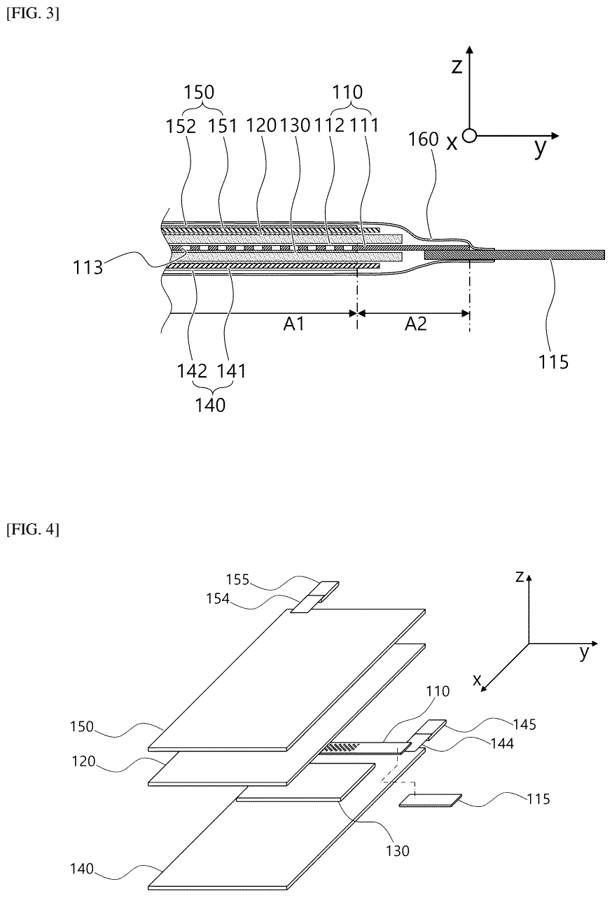

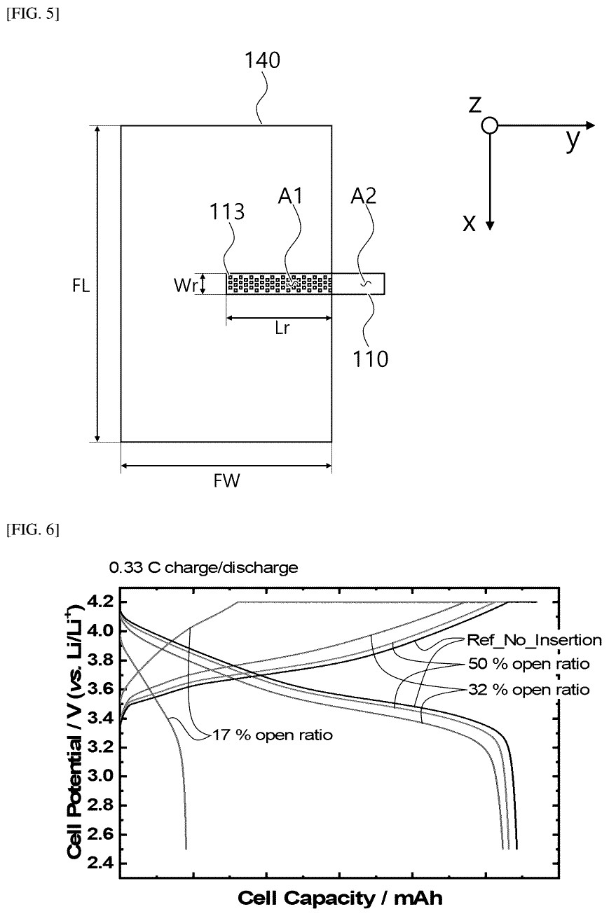

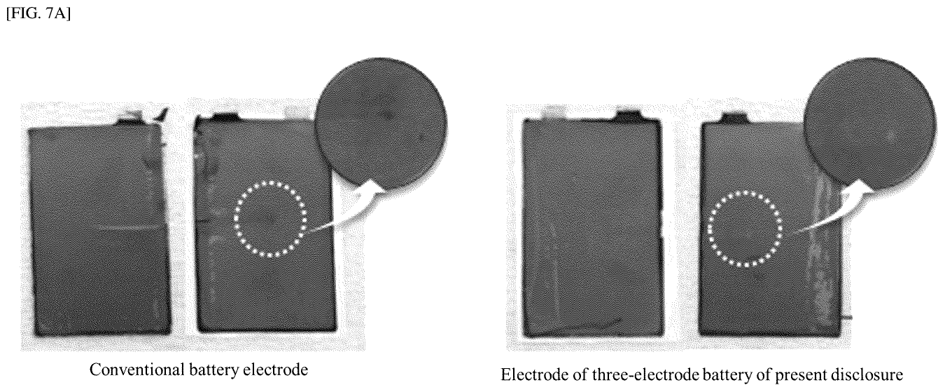

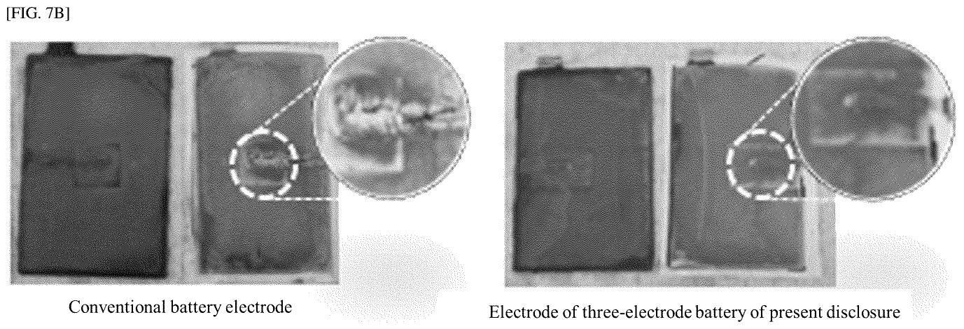

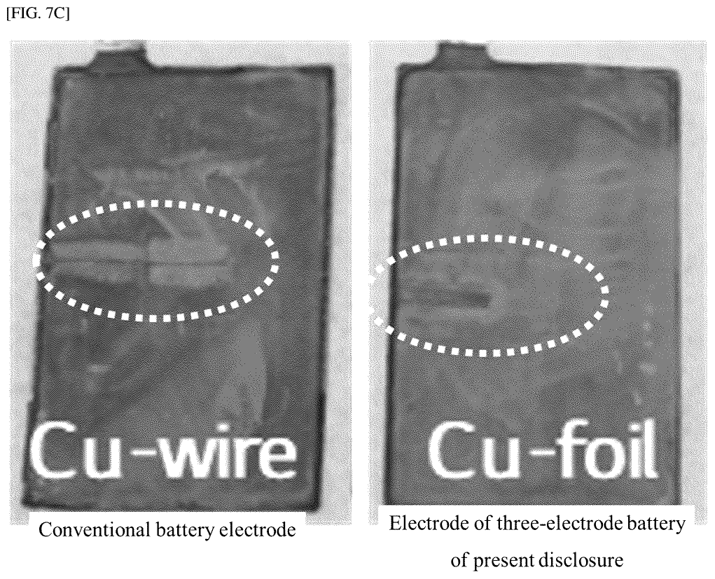

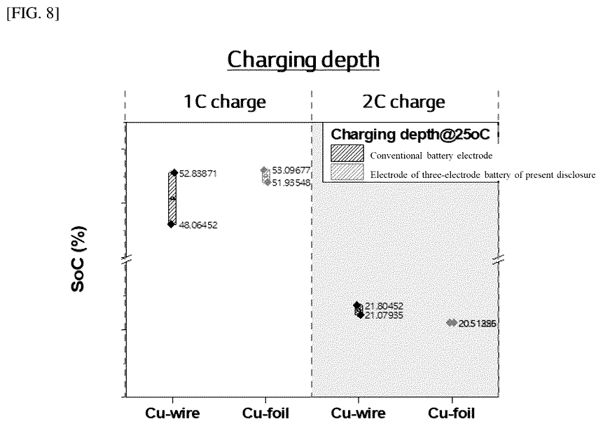

FIG. 3 is a cross-sectional view illustrating a three-electrode battery of the present disclosure. FIG. 4 is an exploded perspective view illustrating a stacked structure of a three-electrode battery of the present disclosure. FIG. 5 is a plan view illustrating a disposition relationship between a first electrode 140 and a reference electrode 110. FIG. 6 is a graph illustrating battery characteristics according to an open ratio of a first region 110. FIGS. 7A to 7C are photographs illustrating a state of a battery electrode according to the reference electrode 110. FIG. 8 is a graph illustrating charging depth at 1 C charge and 2 C charge.

Hereinafter, the three-electrode battery of the present disclosure will be described in detail with reference to FIGS. 3 to 8. In the xyz coordinate system shown in FIGS. 3 to 5, an x-axis direction may be a first direction, a y-axis direction may be a second direction, and a z-axis direction may be a vertical direction.

The three-electrode battery of the present disclosure can be applied to various types of batteries, but may be optimized for a pouch type battery.

As shown in FIG. 3, the three-electrode battery of the present disclosure may include:
a main separator 120;
a film-shaped reference electrode 110 stacked on one side of the main separator 120;
an auxiliary separator 130 stacked on the one side of the main separator 120 with the reference electrode 110 interposed therebetween;
a first electrode 140 and a second electrode 150 stacked with the main separator 120, the reference electrode 110, and the auxiliary separator 130 interposed therebetween; and
a battery case 160 in which the main separator 120, the reference electrode 110, the auxiliary separator 130, the first electrode 140, and the second electrode 150 are accommodated in an inner space.

One of the first electrode 140 and the second electrode 150 may be formed as a cathode, and the other may be formed as an anode.

As shown in FIGS. 3 and 4, the first electrode 140 may include a first electrode current collector 141, a first electrode active material 142 applied to the surface of the first electrode current collector 141, a first electrode tab 144 welded to an uncoated portion of the first electrode current collector 141 on which the first electrode active material 142 is not coated, and a first electrode lead 145 having one end welded to the first electrode tab 144 inside the battery case 160 and the other end protruding out of the battery case 160. The second electrode 150 may also include a second electrode current collector 151, a second electrode active material 152 applied to the surface of the second electrode current collector 151, a second electrode tab 154 welded to an uncoated portion of the second electrode current collector 151 on which the second electrode active material 152 is not coated, and a second electrode lead 155 having one end welded to the second electrode tab 154 inside the battery case 160 and the other end protruding out of the battery case 160.

The material of the main separator 120 and auxiliary separator 130 may include at least one of ethylene homopolymer, propylene homopolymer, ethylene/butene copolymer, ethylene/hexene copolymer, and ethylene/methacrylate copolymer.

The main separator 120 may be located between the first electrode 140 and the second electrode 150.

The main separator 120, the first electrode 140, and the second electrode 150 may be provided in plurality, respectively, and in this case, the auxiliary separator 130 and the reference electrode 110 may be provided on one of the plurality of main separators 120.

Each of the main separator 120, the first electrode 140, and the second electrode 150 may be provided in a sheet shape and stacked so as to cross each other.

The auxiliary separator 130 may be formed in a size capable of covering the reference electrode 110 so that the reference electrode 110 does not directly contact the first electrode 140 or the second electrode 150.

As shown in FIG. 4, the three-electrode battery of the present disclosure may be completed by injecting an electrolyte together with an electrode assembly formed by stacking the the first electrode 140, the main separator 120, the reference electrode 110, the auxiliary separator 130, and the second electrode 150 in this order, or the first electrode 140, the auxiliary separator 130, the reference electrode 110, the main separator 120, and the second electrode 150 in this order into the battery case 160 and then sealing the battery case 160.

At this time, when the first electrode 140 and the second electrode 150 are provided in plurality, respectively, the first electrode tab 144 welded to each of the plurality of first electrodes 140 may be welded to one first electrode lead 145, the second electrode tab 154 welded to each of the plurality of second electrodes 150 may be welded to one second electrode lead 155, and one end of the first electrode lead 145 and one end of the second electrode lead 155 may protrude out of the battery case 160.

In the three-electrode battery of the present disclosure, the reference electrode 110 may have a plurality of perforated holes 113 formed therein. By forming a plurality of perforated holes 113 in the reference electrode 110, it is possible to prevent the reference electrode 110 from interfering with the movement of ions between the first electrode 140 and the second electrode 150 and suppress the formation of a blocking area.

As shown in FIGS. 3 and 5, the reference electrode 110 may include a first region A1 facing the first electrode 140 or the second electrode 150, and a second region A2 protruding from one side of the first electrode 140 or the second electrode 150, wherein the plurality of perforated holes 113 are formed in the first region A1. In other words, the first region A1 may be used to establish a standard for the potential applied to the first electrode 140 or the second electrode 150, and the second region A2 may be used for electrical connection.

The total area of the plurality of perforated holes 113 may be formed to be 30% to 70% of the area of the first region A1. In other words, the total area of the plurality of perforated holes 113 may be formed to be 30% to 70% of the area of the first region A1. When the open ratio is 30% or less in the first region A1, ion diffusion may not be smooth, and when it is 70% or more, the reference electrode may be broken. Therefore, the open ratio formed by the plurality of perforated holes 113 in the first region A1 may be preferably 30% to 70%.

FIG. 6 is a graph illustrating battery characteristics according to an open ratio of a first region. Specifically, for a battery including an electrode assembly stacked in the order of a cathode, a separator, and an anode, it is a graph showing battery characteristics according to the open ratio of the test foil after inserting a test foil having a perforated hole between the separator and the anode. Four batteries were prepared, and test foils having open ratio of 17%, 32%, and 50% were inserted into three batteries, respectively, and the test foil was not inserted into the other battery. As shown in FIG. 7, it can be seen that while the battery provided with the test foil having less than 30% open ratio (17% open ratio) appear to have impaired ion migration, the battery provided with the test foil having an open ration of 30% or more (32% and 50% open ratio) exhibits behavior similar to that of the secondary battery without the test foil itself.

The three-electrode battery of the present disclosure may further include a reference electrode lead 115 having one end fused to the second region A2 of the reference electrode 110 and the other end protruding out of the battery case 160. Since the reference electrode 110 may be formed of a thin metal film or foil, it may not be fused to seal the battery case 160 or have minimal rigidity for connection to an external electric terminal. Accordingly, the reference electrode lead 115, which is a conductor for electrical connection, may be connected to the reference electrode 110, and the reference electrode lead 115 may be welded to the second region A2.

The reference electrode 110 may be provided with a thickness of 45 μm to 120 μm. The thickness of the reference electrode 110 may be determined in consideration of a lifting phenomenon between the first electrode 140 and the second electrode 150, a dent phenomenon caused by shock or vibration applied to the three-electrode battery itself, and the like.

As shown in FIG. 5, in the three-electrode battery of the present disclosure, the first electrode 140 or the second electrode 150 may be provided in a rectangular shape having first and second directions orthogonal to each other as corners. More specifically, the length of the first electrode 140 or the second electrode 150 in the first direction may be longer than the length in the second direction.

At this time, the length Wr of the first region A1 in the first direction may be formed 1% to 3% of the length FL of the first electrode 140 or the second electrode 150 in the first direction, and the length Lr of the first region A1 in the second direction may be formed 5% to 95% of the length Fw of the first electrode 140 or the second electrode 150 in the second direction. The length Lr of the first region A1 in the second direction may be determined in consideration of specifications, materials, number of layers, and types of layers of the first electrode or the second electrode.

In other words, the reference electrode 110 may be provided in a shape extending in a direction perpendicular to the longitudinal direction of the first electrode 140 or the second electrode 150.

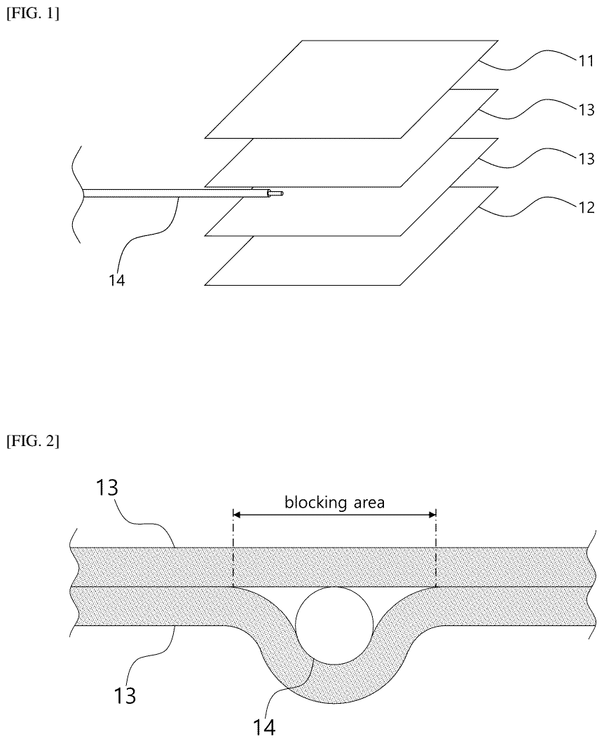

As shown in FIG. 1, the reference electrode 110 may include a foil member 111 forming a body and a reference electrode active material 112 coated on the foil member 111. The reference electrode active material 112 may be applied to the first region A1, and the second region A2 may be formed as an uncoated portion where the reference electrode active material 112 is not applied. For example, the width of the first region A1 and the second region A2 in the first direction may be formed 2 mm, and the length in the second direction may be formed 15 mm for the first region A1 and 3 mm for the second region A2.

The material of the foil member 111 may include at least one of Cu-foil and Al-foil, and the reference electrode active material 112 may be selected from the group consisting of LTO (Li₄Ti₅O₁₂), LFP (LiFePO₄), Li metal, and combinations thereof.

The performance analysis system using the three-electrode battery of the present disclosure may include:
a working electrode connecting part connected to the first electrode 140 to measure an electrode potential of the first electrode 140;
a counter electrode connecting part connected to the second electrode 150;
a reference electrode 110 connecting part connected to the reference electrode 110; and
a measuring part connected to the working electrode connecting part, the counter electrode connecting part, and the reference electrode 110 connecting part to measure the potential of the first electrode 140.

As the first electrode 140, one of a cathode and an anode may be selected according to the analysis purpose.

FIGS. 7A and 7C are photographs of electrode surfaces in a battery when the reference electrode 110 of the three-electrode battery of the present disclosure is applied and when a conventional wire-type reference electrode is applied. In FIGS. 7A and 7C, on the left, a conventional wire-type reference electrode is applied, and on the right, the reference electrode 110 of the present disclosure is applied.

FIG. 7A is an electrode extracted from a battery with 100% state of charge (SoC). It can be seen that the unreacted area is observed in the conventional type, but the electrode of the three-electrode battery of the present disclosure does not have an unreacted area.

FIG. 7B is an electrode extracted from a battery applied with 1 C/1 C, 20 cycles of charging and discharging. In the conventional type, it can be seen that Li precipitation is non-uniform in the vicinity of the wire-type reference electrode.

FIG. 7C is a photograph extracted from a battery dedicated to fast charge. In the conventional type, precipitation deepening occurs in the area adjacent to the wire-type reference electrode, but in the electrode of the three-electrode battery of the present disclosure, precipitation in the area adjacent to the reference electrode 110 is alleviated.

FIG. 8 is a graph illustrating charging depth at 1 C charge and 2C charge. It can be seen that the three-electrode battery of the present disclosure has a reduced variation in charging depth compared to the conventional battery.

Although embodiments according to the present disclosure have been described above, these are merely examples, and those skilled in the art will understand that various modifications and embodiments of equivalent range are possible therefrom. Therefore, the true technical protection scope of the present disclosure should be defined by the following claims.

### EXPLANATION OF SYMBOLS

110 . . . Reference electrode, 111 . . . Foil member, 112 . . . Reference electrode active material, 113 . . . Perforated hole, 115 . . . Reference electrode lead, 120 . . . Main separator, 130 . . . Auxiliary separator, 140 . . . First electrode, 141 . . . First electrode current collector, 142 . . . First electrode active material, 144 . . . First electrode tab, 145 . . . First electrode lead, 150 . . . Second electrode, 151 . . . Second electrode current collector, 152 . . . Second electrode active material, 154 . . . Second electrode tab, 155 . . . Second electrode lead, 160 . . . Battery case, A1 . . . First region, A2 . . . Second region

### INDUSTRIAL APPLICABILITY

According to a three-electrode battery and performance analysis system using the same of the present disclosure, it is possible to minimize the area of the blocking area due to the reference electrode, and suppress the occurrence of circuit problems such as internal short circuit or electrode damage such as electrode pitting due to changes in battery internal pressure.

The three-electrode battery of the present disclosure and a performance analysis system using the same may be capable of highly reliable separation analysis of the cathode/anode regardless of the electrode's own physical properties and whether or not it is operated.

The three-electrode battery of the present disclosure may be advantageous for analysis of Si/SiO batteries with significant thickness changes or long-term degradation analysis.

In the three-electrode battery of the present disclosure, the effect of reducing the three-electrode deviation can be expected due to the reduction of the blocking area.

The three-electrode battery of the present disclosure has a structure that is easy to design for a medium or large-sized battery, and can be applied regardless of the stack or area of electrodes.

1. A three-electrode battery comprising:
a main separator;
a film-shaped reference electrode on a first side of the main separator;
an auxiliary separator on the first side of the main separator with the reference electrode interposed therebetween;
a first electrode and a second electrode disposed with the main separator, the reference electrode, and the auxiliary separator interposed therebetween; and
a battery case accommodating the main separator, the reference electrode, the auxiliary separator, the first electrode, and the second electrode in an inner space therein.

2. The three-electrode battery of claim 1, wherein the reference electrode comprises a plurality of perforated holes.

3. The three-electrode battery of claim 2, wherein the reference electrode further comprises:
a first region facing the first electrode or the second electrode; and
a second region protruding from one side of the first electrode or the second electrode, and
wherein the plurality of perforated holes are formed in the first region.

4. The three-electrode battery of claim 3, further comprising:
a reference electrode lead having one end coupled to the second region of the reference electrode and the other end protruding out of the battery case.

5. The three-electrode battery of claim 3, wherein a total area of the plurality of perforated holes is formed to be 30% to 70% of the area of the first region.

6. The three-electrode battery of claim 3, wherein the first electrode or the second electrode has a rectangular shape having a first direction and a second direction orthogonal to each other as corners, and
when a length of the first electrode or the second electrode in the first direction is formed to be longer than a length in the second direction;
a length of the first region of the reference electrode in the first direction is formed to be 1% to 3% of the length of the first electrode or the second electrode in the first direction, and
a length of the first region of the reference electrode in the second direction is formed to be 5% to 95% of the length of the first electrode or the second electrode in the second direction.

7. The three-electrode battery of claim 1, wherein the reference electrode comprises:
a foil member forming a body, and
a reference electrode active material coated on the foil member.

8. The three-electrode battery of claim 7, wherein a material of the foil member comprises at least one of Cu-foil and Al-foil.

9. The three-electrode battery of claim 7, wherein the reference electrode active material is selected from the group consisting of LTO (Li₄Ti₅O₁₂), LFP (LiFePO₄), Li metal, and a combinations thereof.

10. A performance analysis system using the three-electrode battery of claim 1, comprising:
a working electrode connecting part connected to the first electrode to measure an electrode potential of the first electrode;
a counter electrode connecting part connected to the second electrode;
a reference electrode connecting part connected to the reference electrode; and
a measuring part connected to the working electrode connecting part, the counter electrode connecting part, and the reference electrode connecting part to measure the electrode potential of the first electrode.
